(19) United States
(12) Patent Application Publication
(10) Pub. No.: US 2021/0039144 A1
(43) Pub. Date: Feb. 11, 2021

(54) PIPELINE PIG WITH ROTATING CIRCUMFERENTIAL BRUSH AND SCRAPER DISC WITH WEAR-WEAR-RESISTANT INSERT

(71) Applicant: 2066128 Alberta Ltd., Edmonton, CA (US)

(72) Inventor: Michael BOYD, Edmonton (CA)

(21) Appl. No.: 16/965,939

(22) PCT Filed: Feb. 20, 2019
(86) PCT No.: PCT/CA2019/050207

§ 371 Date: Jul. 29, 2020

Related U.S. Application Data
(60) Provisional application No. 62/632,978, filed on Feb. 20, 2018.
(60) Provisional application No. 62/746,872, filed on Oct. 17, 2018.

(51) Int. Cl. B08B 9/055; F16L 55/26

(52) U.S. Cl. CPC B08B 9/0557; B08B 2209/055; F16L 55/26

(57) ABSTRACT

A pipeline pig includes a pair of axially spaced apart sleeve housings containing an axially extending central shaft so as to define therebetween a fluid flow path that extends axially through the pipeline pig. A circumferential brush is rotatably mounted on the central shaft, and exposed between the pair of sleeve housings. A turbine wheel is disposed in the flow path and attached to the circumferential brush. Vanes of the turbine wheel are configured such that axial fluid flow through the fluid flow path impinging on the vanes drives rotation of the turbine wheel and hence rotation of the attached circumferential brush about the central shaft. A scraper disc for a pipeline pig includes a body formed from a resilient material, and an insert formed from a wear-resistant material. The insert is incorporated into the body and defines one or more edges coinciding with the outer circumference of the body.

### FIELD OF THE INVENTION

The present invention relates to a pipeline pig that includes a rotating circumferential brush that can be used to clean the top inner surface of a pipeline. The present invention further relates to a scraper disc for a pipeline pig, where the scraper disc has a wear-resistant insert for scraping the inner surface of a pipeline.

### BACKGROUND OF THE INVENTION

Pipelines used to transport oil and gas are often subject to corrosion as a result of various components found in the oil and gas. One type of corrosion is referred to as “top-of-line” corrosion and is caused when liquids, in particular water, condense on the top inner surface of the pipeline. This occurs when a pipeline is not operated “liquid full”—i.e., the combined gas/liquid flow is such that the liquid portion of the flow only contacts a portion of the inner surface of the pipeline. The corrosion is often a result of contaminants in the gas such as carbon dioxide, hydrogen sulfide and/or organic acids, and water condensation as a result of pressure and temperature changes in the pipeline.

Corrosion inhibitors are often injected into the pipeline with the oil and gas to prevent corrosion. However, when the pipeline is not operated “liquid full”, the corrosion inhibitor may not come into contact with the top inner surface of the pipeline. As a result, there is no effective way to treat the top inner surface of the pipeline with corrosion inhibitors. This condensation is especially prevalent in the portion of the pipeline near the wellhead where the oil and gas cools as it leaves the well.

Pipeline pigs are used to clean the interior of a pipeline and may include wipers, scrapers and brushes to scrape and brush the interior surface. Brushes may be particularly effective, but may only clean in an axial direction as a result of the pig's linear progress through the pipeline.

When pigging a pipeline, the pipeline is typically not “liquid full”, and there is no way to guarantee that injecting corrosion inhibitors during a pigging operation will result in full contact between the corrosion inhibitor and the top inner surface of the pipeline. As well, corrosion products and other debris may accumulate in front of the pig.

Scraper discs (also referred to as wiper discs) typically will display a relatively sharp leading edge to provide a scraping action. However, the leading edge will typically wear quickly. Additionally, because the scraper disc is usually made of a resilient material to allow for irregularities in the pipeline, the wiping or scraping action may be relatively ineffective.

### SUMMARY OF THE INVENTION

In one aspect, the present invention comprises a pipeline pig. The pipeline pig defines an axial direction from a tail end of the pipeline pig to a nose end of the pipeline pig, and a radial direction normal to the axial direction. The pipeline pig comprises a pair of sleeve housings, a central shaft, a circumferential brush, and a turbine wheel. The pair of sleeve housings are axially spaced apart. The central shaft extends axially, and is disposed within the sleeve housings so as to define a fluid flow path between the shaft and the sleeve housings. The fluid flow path extends axially through the pipeline pig from the tail end to the nose end. The circumferential brush is rotatably mounted on the central shaft. The circumferential brush is exposed between the pair of sleeve housings. The turbine wheel comprises a plurality of vanes disposed in the flow path and attached to the circumferential brush. The vanes are configured such that an axial fluid flow through the fluid flow path impinging on the vanes drives rotation of the turbine wheel and hence rotation of the attached circumferential brush about the central shaft.

In one embodiment of the pipeline pig, the circumferential brush is rotatably mounted on the central shaft by a hub sleeve, and at least one wheel. The hub sleeve is rotatably mounted on the central shaft. The at least one wheel is attached to the hub sleeve and the circumferential brush. The at least one wheel defines at least one wheel opening that permits the axial fluid flow through the fluid flow path. The at least one wheel may be a spoked wheel. The at least one wheel may comprise a pair of axially spaced apart wheels.

In one embodiment of the pipeline pig having at least one wheel, the pipeline pig further comprises a first annular seal element disposed axially between and in abutting relationship with the sleeve housing most proximal to the tail end of the pipeline pig and a first wheel of the at least one wheel. The first annular seal may line an inner wall of the sleeve housing most proximal to the tail end of the pipeline pig. The turbine wheel may be disposed within the first annular seal.

In one embodiment of the pipeline pig having at least one wheel, the pipeline pig further comprises a second annular seal element disposed axially between and in abutting relationship with the sleeve housing most proximal to the nose end of the pipeline pig and a second wheel of the at least one wheel.

In one embodiment of the pipeline pig, the circumferential brush comprises bristles. In another embodiment of the pipeline pig, the circumferential brush comprises an abrasive material.

In one embodiment of the pipeline pig, the circumferential brush comprises an uninterrupted circumferential cleaning surface. In another embodiment of the pipeline pig, the circumferential brush comprises a circumferential cleaning surface that defines at least one gap.

In one embodiment of the pipeline pig, the sleeve housing most proximal to the tail end of the pipeline pig is mounted on the central shaft by a disc defining a plurality of disc openings that permit the axial fluid flow through the fluid flow path. The plurality of disc openings may be configured to increase velocity of the axial fluid flow through the disc openings. The plurality of disc openings may be configured to direct the axial fluid flow tangentially onto the vanes of the turbine wheel.

In one embodiment of the pipeline pig, the vanes of the turbine wheel are cup-shaped.

In one embodiment of the pipeline pig, the vanes of the turbine wheel are removably attached to a hub of the turbine wheel. The vanes may define a mounting pin removably inserted into one of a plurality of first pockets or apertures defined by the hub of the turbine wheel. Each of the mounting pins may define a mounting pin aperture, and each of the vanes may be removably secured to the hub of the turbine wheel by a pin that is inserted into the mounting pin aperture via an aligned one of a plurality of second pockets or apertures defined by the hub of the turbine wheel.

In one embodiment of the pipeline pig, either one or both of the sleeve housings defines a flange for mounting of a scraper disc or a scraper cup.

In another aspect, the present invention comprises a scraper disc for a pipeline pig. The scraper disc defines a longitudinal direction parallel to a longitudinal axis of a pipeline when the scraper disc is inserted therein, and a radial direction normal to the longitudinal direction and extending outwardly from a central point of the scraper disc. The scraper disc comprises a body and at least one insert. The body is formed from a resilient material, and has an outer circumference. The at least one insert is formed from a wear-resistant material. The at least one insert is incorporated into the body, and defines at least one edge coinciding with the outer circumference of the body for scraping against an inner wall of a pipeline.

In one embodiment of the scraper disc, the body is molded, and the insert is cast incorporated into the body.

In one embodiment of the scraper disc, the resilient material comprises an elastomer. The elastomer may comprise a polyurethane material. The elastomer may comprise a rubber material.

In one embodiment of the scraper disc, the wear-resistant material comprises a metallic material. In one embodiment of the scraper disc, the wear-resistant material comprises a ceramic material. In one embodiment of the scraper disc, the wear-resistant material comprises tungsten carbide.

In one embodiment of the scraper disc, the edge is disposed at a leading edge of the body.

In one embodiment of the scraper disc, the at least one insert comprises a ring, and a plurality of circumferentially spaced apart blades attached to and extending radially outward from the ring. Each of the blades defines one of the at least one edge such that the at least one edge comprises a plurality of circumferentially spaced apart edges.

In embodiments of the scraper disc where the at least one insert comprises a ring, and a plurality of circumferentially spaced apart blades, the edges may be rounded to match the outer circumference of the body. Each of the blades may be angled away from a transverse plane normal to the longitudinal direction. Each of the blades may define at least one blade opening through which the resilient material of the body extends. Each of the blades may taper from the outer circumference of the body toward an attachment point of the blade to the ring.

In embodiments of the scraper disc where the at least one insert comprises a ring, and a plurality of circumferentially spaced apart blades, the at least one insert may comprise a first insert and a second insert. The plurality of circumferentially spaced apart blades of the first insert may be axially spaced apart from the plurality of circumferentially spaced apart blades of the second insert. The plurality of edges of the first insert may be circumferentially offset from the plurality of edges from the second insert, such that any longitudinal line along an outer surface of the body is intersected by at least one of the edges.

In embodiments of the scraper disc where the at least one insert comprises a ring, and a plurality of circumferentially spaced apart blades, the ring may comprise a flexible cable. The flexible cable may comprise a looped end that encircles an aperture defined by the body of the scraper disc. The aperture defined by the body of the scraper disc may be for through passage of a fastener for securing the scraper disc to the pipeline pig. Each of the blades may be secured to the flexible cable by a wire wound around the flexible cable and the blade through an opening defined by the blade.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 shows a perspective view of an axial cross-section of an embodiment of a pipeline pig of the present invention.

FIG. 2 shows a detailed view of the rotating elements of the pipeline pig of FIG. 1.

FIG. 3 shows a detailed view of the first seal element of the pipeline pig of FIG. 1.

FIG. 4 shows a detailed view of the locating shaft step on the leading side of the central shaft of the pipeline pig of FIG. 1.

FIG. 5 shows a detailed view of the positioning ring on the trailing side of the central shaft of the pipeline pig of FIG. 1.

FIG. 6A shows a perspective view of an embodiment of a turbine wheel of the pipeline pipe of FIG. 1, showing the turbine wheel's cup-shaped removable vanes, and where the hub of the turbine wheel is shown as transparent to show the attachment of the vanes thereto.

FIG. 6B is a perspective view of a single vane of the turbine wheel of FIG. 6A, showing the mounting pin of the vane.

FIG. 7 shows a perspective view of an axial cross-section of the pipeline pig of FIG. 1, when assembled with a plurality of urethane cups and scrapers.

FIG. 8 a perspective view of one embodiment of a scraper disc of the present invention, which may be used with the pipeline pig of the present invention.

FIG. 9 shows a perspective view of a portion of the scraper disc of FIG. 8, with the body of the scraper disc shown as transparent to show details of the scraper inserts.

FIG. 10 shows a perspective view of a single scraper insert, in isolation, from the body of the scraper disc of FIG. 8.

FIG. 11 shows a perspective view of a portion of an alternative embodiment of a scraper disc of the present invention, with the body of the scraper disc shown as transparent to show details of an alternative embodiment of the scraper inserts.

FIG. 12 shows a perspective view of a further alternative embodiment of a scraper disc of the present invention, with the body of the scraper disc shown as transparent to show details of a further alternative embodiment of the scraper inserts.

FIG. 13 shows an exploded perspective view of a sub-assembly including an embodiment of a scraper disc of the present invention, which sub-assembly may be mounted to the nose end of a pipeline pig of the present invention.

### DETAILED DESCRIPTION OF EMBODIMENTS OF THE INVENTION

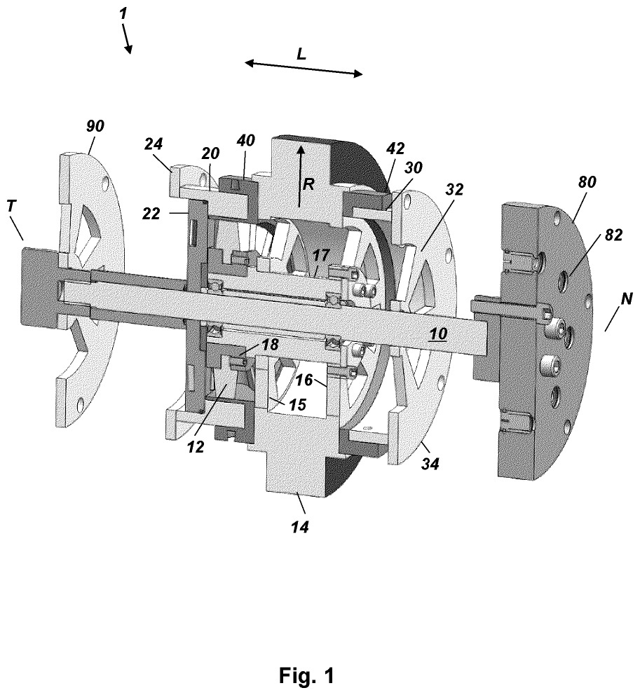

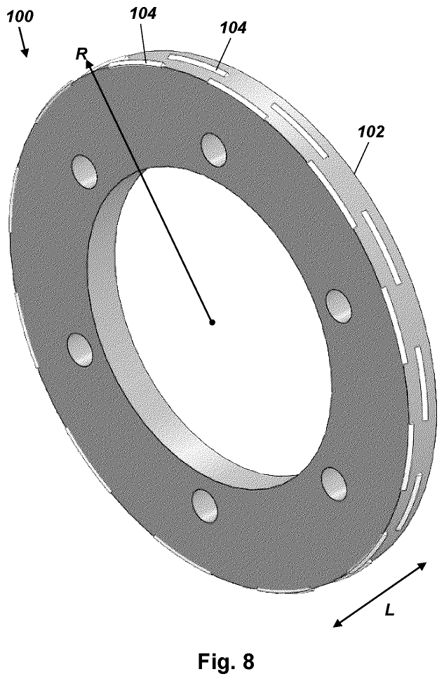

FIG. 1 shows one embodiment of a pipeline pig of the present invention. FIG. 8 shows an embodiment of a scraper disc of the present invention, which may be used with a pipeline pig of the present invention. As used herein, the terms “axial” or “longitudinal” refer to the longitudinal axis of a pipeline. Referring to FIG. 1, in respect to the pipeline pig, “axial” or “longitudinal” is parallel to the long axis (L) of the pig from the nose (N) of the pig to the tail (T) of the pig, when the pig is installed in the pipeline. The terms “transverse” or “radial” refers to a plane or direction (R) which is normal to the longitudinal axis. Referring to FIG. 8, in respect to the scraper disc, “axial” or “longitudinal” is parallel to the longitudinal axis (L) of the pipeline when the scraper disc is inserted therein. The “transverse” plane or direction may be parallel with the plane of the scraper disc when installed on a pig and installed in a pipeline. The term “radial” shall mean a position or arrangement where an imaginary line (R) may be drawn through an element and a central point of the scraper disc.

Pipeline Pig with Rotating Circumferential Brush.

Referring to FIG. 1, the pipeline pig (1) comprises a longitudinal central shaft (10) which passes through the pig and a turbine wheel (12), which rotates about the shaft (10) to provide motive power to a rotating circumferential brush (14). The turbine wheel (12) is actuated by axial flow of fluid through a fluid flow path of the pig (1). The brush (14) comprises at least one, and preferably first and second wheels (15, 16) which are mounted to a hub sleeve (17), which rotates about the shaft (10). The first and second wheels (15, 16) are spoked to permit fluid flow through them. Bearings disposed one at each end of the hub sleeve (17) facilitate rotation about the shaft (10). The turbine wheel (12) is affixed to the hub sleeve (17) with keyways and keys (18).

The circumferential circular brush (14) may comprise a relatively uniform and dense brush of bristles, generally of the type conventionally used with pipeline pigs. Alternatively, the brush (14) may comprise an outer ring of a resilient abrasive material, which acts to clean the inside surface of a pipe as it moves axially through the pipe and as it rotates within the pipe. The brush (14) may provide an uninterrupted cleaning surface completely around the circumference of the pig, or may include gaps in the cleaning surface. Gaps may reduce friction of the pig (1) within the pipeline, but at the expense of cleaning efficiency.

The pig (1) is made up of a number of discs, rings, and sleeve housings (20, 30), which mount to the shaft (10). The central shaft (10) with the sleeve housings (20, 30) and other components create an annular space therebetween that defines the fluid flow path through the pig (1). A first sleeve housing (20) mounts to a slotted disc (22) and comprises a flange (24). A second sleeve housing (30) mounts to a slotted disc (32) on the opposing side of the brush (14), and also comprises a flange (34).

Axial fluid flow through the pig (1) will rotate the turbine wheel (12), causing the brush (14) to rotate by means of the hub sleeve (17) on the central shaft (10). In one embodiment, the first slotted disc (22) is a nozzle plate, defining nozzle openings which increase fluid velocity and directs the fluid tangentially into the vanes of the turbine wheel (12), which may be cup-shaped as a result. Alternatively, a more conventional turbine wheel (12) may be provided with curved vanes which are acted upon by directly axial fluid flow.

In one embodiment, seal elements (40, 42) are provided to direct fluid flow as desired, minimize ingress of fine solid particles, and to reduce friction between rotating elements and stationary elements. As such, the seal elements (40, 42) may be made of a low-friction material such as polyethylene, and preferably a high molecular weight polyethylene such as HDPE (high-density polyethylene) or UHMW (Ultra-high-molecular-weight polyethylene) (also known as high-modulus polyethylene). This material is self-lubricating and is highly resistant to wear and abrasion.

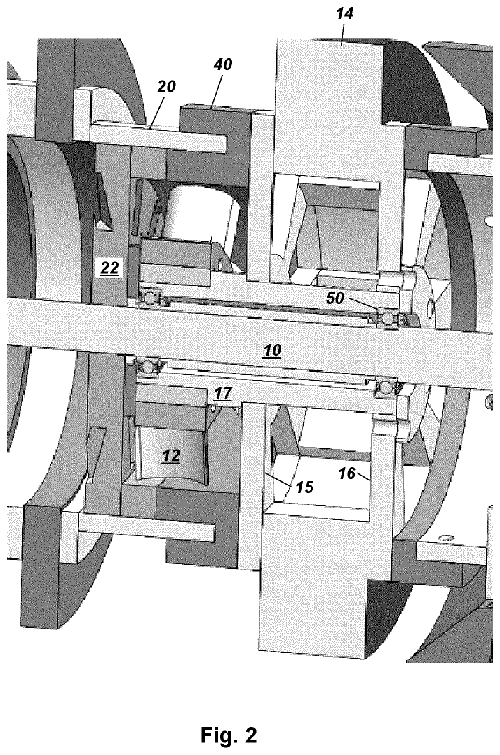

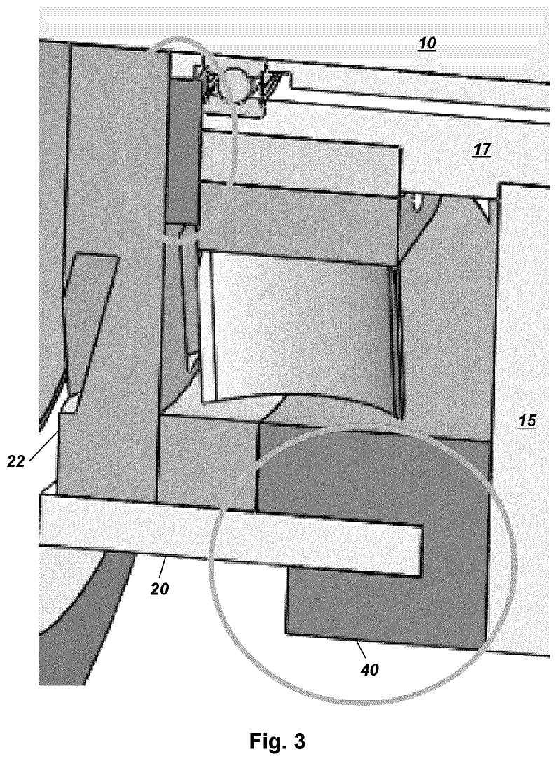

Referring to FIG. 2, an annular first seal element (40) is disposed between the first sleeve housing (20) and the rotating brush wheel (15). The first seal element (40) defines a channel which receives the sleeve housing (20) and abuts against the rotating brush wheel (15). By receiving the sleeve housing (20) in the channel of the first seal element (40), the first seal element (40) lines an inner wall of the sleeve housing (20). The turbine wheel (12) rotates within inner diameter of the first seal element (40), with a minimized clearance to allow free rotation while minimizing fluid leakage around the outside of the vanes of the turbine wheel (12).

Referring to FIG. 1, an annular second seal element (42) is disposed between the second sleeve housing (30) and the opposite rotating brush wheel (16). The second seal element (42) may be configured similarly to the first seal element (40), or may have a simpler “L” shaped axial cross-section, as shown in FIG. 1. The fluid pressure will be lower on this downstream side of the brush wheel (16), and therefore the second seal element (42) does not require as much sealing surface as the first seal element (40).

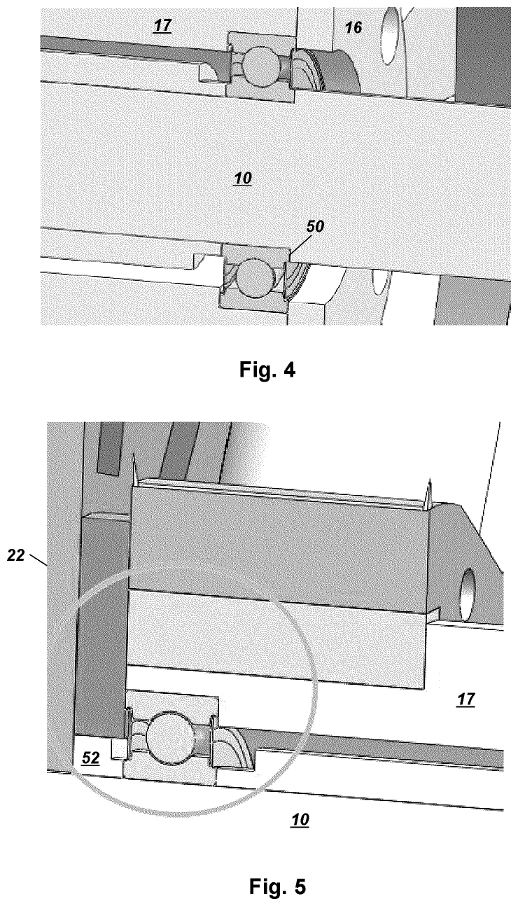

Referring to FIG. 4, the rotating elements are located on the central shaft (10) by a step (50) formed near the end of the shaft (10) most proximal to the nose end of the pipeline pig (1). The step (50) abuts against the bearing disposed at the end of the hub sleeve (17) most proximal to the nose (N) of the pipeline pig (1). Referring to FIG. 5, a ring (52) is affixed to the central shaft (10) outside the other bearing to restrict axial movement of the rotating elements. The ring (52) may be welded to the shaft (10) and bolted to the first slotted disc (22).

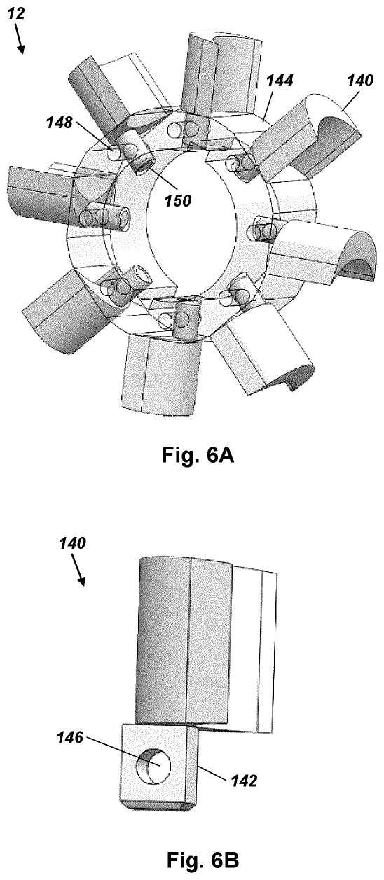

Referring to FIGS. 6A and 6B, in one embodiment, the turbine wheel (12) comprises a plurality of vanes (140), which in one preferred embodiment are moveable, and removably attached to the hub (144) of the turbine wheel 912). A vane (140) may mount to the base by a mounting pin (142) which inserts into one of the radially-extending first pockets or apertures (150) formed in the hub (144) of the turbine wheel (12) and may be locked therein by a pin (not shown) that passes through an mounting pin aperture (146) of the mounting pin (142) aligned with one of the axially-extending second pockets or apertures (148) formed in the hub (144) of the turbine wheel (12). The vanes (140) may be replaced with vanes of different sizes or configurations, providing adjustability to accommodate a desired pressure drop across the turbine and torque generation.

The pig (1) may be provided with a gear assembly to provide driving engagement from the turbine wheel (12) to the circumferential brush. The gear assembly may comprise a plurality of gears that are configured to have a torque multiplier effect on the torque transmitted from the turbine wheel (12) to the circumferential brush (14), at a given pressure of the fluid flowing through the fluid flow path defined by the pig (1). This may be useful to provide sufficient “break away” torque to overcome the friction between the circumferential brush and the inner wall of the pipeline.

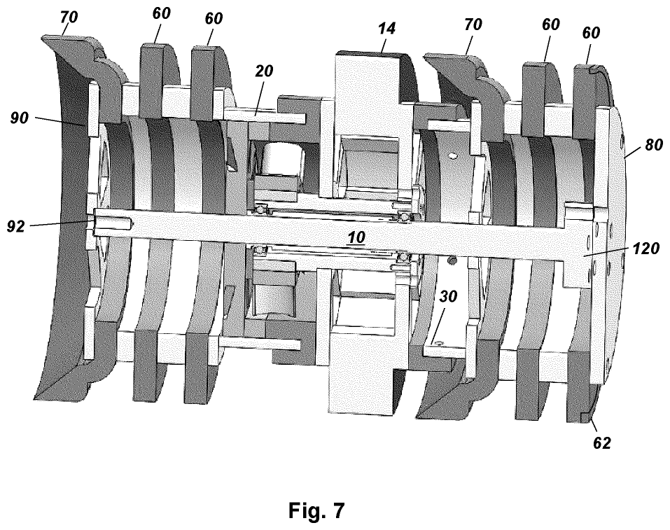

The pig (1) may further comprise conventional urethane cups and scrapers, assembled with suitable spacers and plates. In the embodiment shown in FIG. 7, scraper discs (60) and cups (70) are provided on both the trailing and leading sides of the rotating brush (14).

Referring to FIG. 7, the pig (1) is assembled by mounting the leading plate (80) onto the enlarged head (120) of the shaft (10), and sliding the various components into position and affixing as necessary with bolts or other fasteners. The trailing plate (90) may be mounted by a single axial bolt (92) into the centerline of the shaft (10). The trailing plate (90) defines numerous slots or openings for fluid flow into the fluid flow path of the pig (1). The leading plate (80) also defines slots or openings for fluid flow out of the fluid flow path of the pig (1), but these slots or openings may be reduced in total cross-sectional area, which will assist in propelling the pig (1) through the pipeline.

Referring to FIG. 1, in one embodiment, the leading plate (80) includes a plurality of jetting nozzles (82) that focus exiting fluid in a higher pressure stream, which may assist in loosening solids which have accumulated in front of the pig (1) as it progresses through the pipeline. If the pig (1) gets stuck behind an accumulation of material, a sustained pulse of fluid may increase the propelling pressure to move the pig (1), and fluid jetting in front of the pig (1) may help dislodge solids.

Scraper Disc with Scraper Insert Ring with Radially Projecting Blades.

Referring to FIG. 7, in one embodiment, the scraper disc (60) has a leading edge that includes a scraper ring (62) comprised of a wear resistant material such as tungsten carbide. Conventional scraper discs are made of cast polyurethane. The scraper ring (62) may be molded into the leading edge during the casting process. The scraper ring (62) may present a sharp leading edge, which acts to more effectively scrape the inside of the pipeline.

FIG. 8 shows an embodiment of a scraper disc (100) of the present invention. The scraper disc (100) has a scraper disc body (102) that defines a central opening, facilitating mounting onto the pipeline pig (1) in any suitable manner, as is known in the art. The scraper disc body (102) is generally circular in the transverse plane, and defines an outer diameter. The outer diameter of the scraper disc body (102) is typically coincident with the inner diameter of a pipeline for which the pig (1) is intended to be used. In one embodiment, the scraper disc body (102) comprises a resilient material, preferably an elastomer, such as a polyurethane or a rubber.

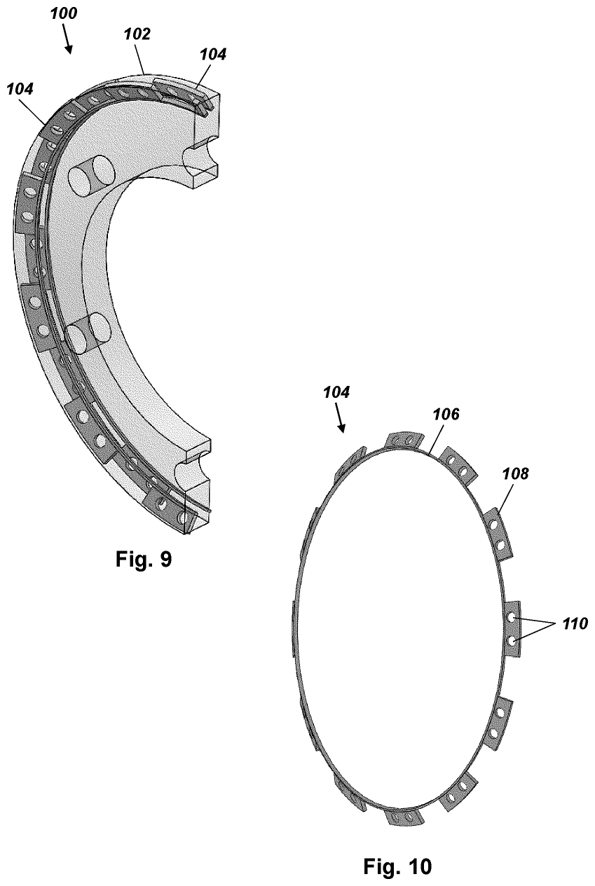

Referring to FIG. 9, the scraper disc (100) has two scraper inserts (104). Referring to FIG. 10, the scraper insert (104) comprises a ring (106) and a plurality of outwardly radially projecting blades (108), which is molded into the scraper disc body (102). The blades (108) are arrayed on a circular arc which matches the outer circumference of the scraper disc body (102), such that the outer edges of the blades (108) coincide with the outer circumference of the scraper disc body (102), as may be seen in FIG. 8. In some embodiments, the blades (108) are spaced regularly around the circumference of the scraper disc (100). In one embodiment, the scraper insert (102) and blades (108) may be comprised of a wear resistant material such as tungsten carbide or another metallic or ceramic material.

The scraper disc (100) may comprise two or more scraper inserts (104), longitudinally spaced apart and circumferentially offset from each other, preferably such that a longitudinal line on the surface of the scraper disc (100) will always intersect at least one of the blades (108). As a result, when installed and in use, the entire surface area of inner surface of a pipeline will be subject to the scraping action of at least one of the blades (108).

Referring to FIG. 10, in one embodiment, the blades (108) are angled away from a transverse plane, and defines one or more blade openings (110) through which the elastomeric material of the scraper disc body (102) may be set.

Each blade (108) may be manufactured with a straight outer edge, which will then wear down to conform to the curve of the pipeline. However, in preferred embodiments as shown in FIG. 10, each blade (108) comprises a rounded outer edge, to match the curve of the scraper disc body (102) and the inner wall of the pipeline.

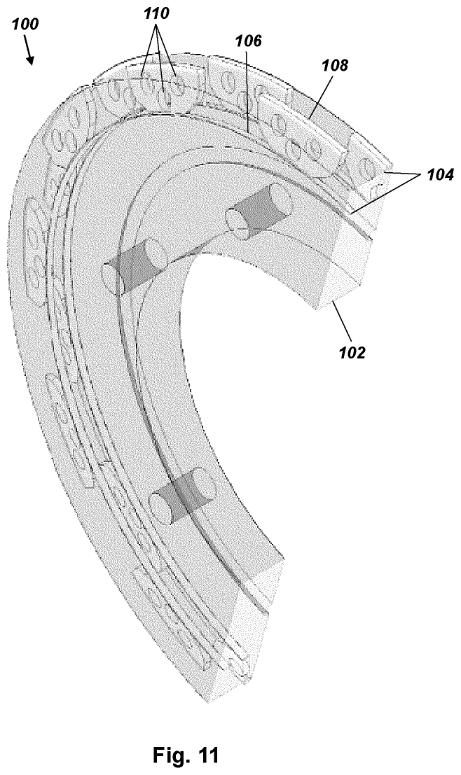

FIG. 11 shows an alternative embodiment of a scraper disc (100). This embodiment differs from the embodiment shown in FIG. 9 in that the shape of the blades (108) are tapered to its attachment point with the ring (106). It is believed that reducing the contact area of the blade (108) to the ring (106) may reduce tearing or delamination of the urethane due to stress and deflection of the blades (108).

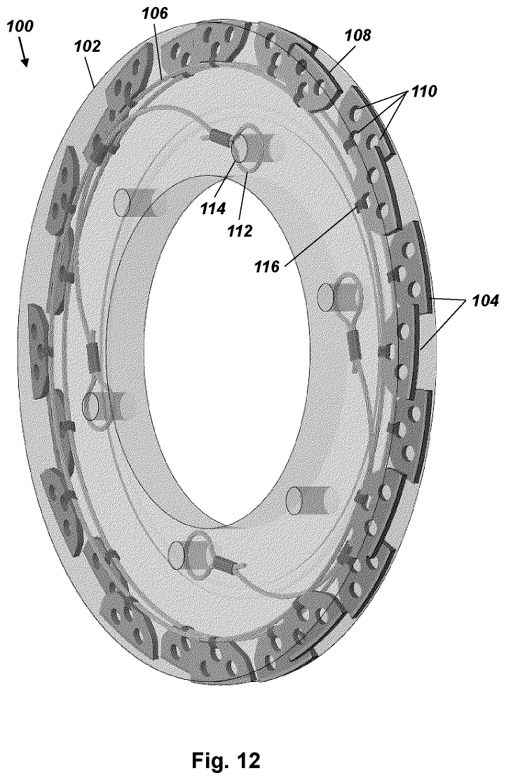

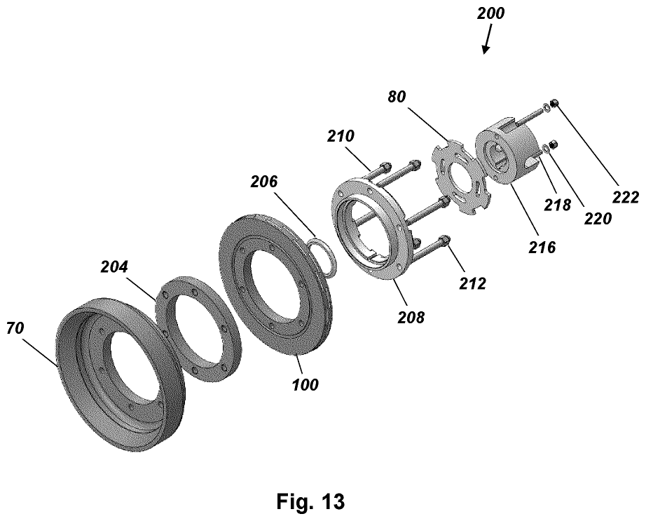

FIG. 12 shows a further alternative embodiment of a scraper disc (100). This embodiment differs from the embodiment shown in FIGS. 9 and 11 in respect to the construction of the scraper inserts (104) and the attachment of the blades (108) thereto. In this embodiment, the ring (106) of the scraper insert (104) is formed by a piece of flexible cable, such as a high tensile strength wire rope. Each of the ends of the cable form a loop (112) that encircles an aperture (114) formed in the body (102) of the scraper disc (100). During molding of the body (102), the aperture (114) is filled with part of the mold form, and accordingly, engagement of the loop (112) with the mold form provides a convenient way to limit movement of the scraper insert (104) during the molding of the body (102). In use, the aperture (114) allows for through passage of studs for securing the scraper disc (100) to a pipeline pig (1) (as described below with reference to FIG. 13). In this embodiment, the blades (108) are secured to the ring (106) by wire (116) wound around the ring (106) and each of the blades (108) through the blade opening (110) most proximal to the ring (106). The wire (116) may be made of any material that will withstand the high temperature of the liquefied elastomeric material used to form the body (102) during the molding process. As a non-limiting example, the wire (116) may be made of a metallic material.

FIG. 13 shows an embodiment of a sub-assembly (200) of a pipeline pig (1) that includes an embodiment of a scraper disc (100) of the present invention. The sub-assembly (200) may be mounted to the nose end of the pipeline pig (1). Proceeding in the direction from the tail of the pig (1) to the nose of the pig (1), the sub-assembly (200) includes a pressure cup (70), a spacer (204), a scraper disc (100), a regulator spacer (206), a front end bolt plate (208), a flow regulator leading plate (80) and a front bumper (216). The pressure cup (70), the spacer (204), the scraper disc (100), and the front end bolt plate (208) are secured to the flange (34) of the second sleeve housing (30) of the pipeline pig (1) (see FIG. 1) by threaded studs (210) and nylon lock nuts (212). The flow regulator leading plate (80) and the front bumper (216) are secured to the remainder of the sub-assembly (200) by threaded studs (218), washers (220) and nylon lock nuts (222).

Definitions and Interpretation.

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

1. A pipeline pig defining an axial direction from a tail end of the pipeline pig to a nose end of the pipeline pig, and a radial direction normal to the axial direction, the pipeline pig comprising:
(a) a pair of axially spaced apart sleeve housings;
(b) an axially extending central shaft disposed within the sleeve housings so as to define a fluid flow path between the shaft and the sleeve housings, the fluid flow path extending axially through the pipeline pig from the tail end to the nose end;
(c) a circumferential brush rotatably mounted on the central shaft, wherein the circumferential brush is exposed between the pair of sleeve housings; and
(d) a turbine wheel comprising a plurality of vanes disposed in the flow path and attached to the circumferential brush, wherein the vanes are configured such that an axial fluid flow through the fluid flow path impinging on the vanes drives rotation of the turbine wheel and hence rotation of the attached circumferential brush about the central shaft.

2. The pipeline pig of claim 1, wherein the circumferential brush is rotatably mounted on the central shaft by:
(a) a hub sleeve rotatably mounted on the central shaft; and
(b) at least one wheel attached to the hub sleeve and the circumferential brush, wherein the at least one wheel defines at least one wheel opening that permits the axial fluid flow through the fluid flow path.

3. The pipeline pig of claim 2, wherein the at least one wheel is a spoked wheel.

4. The pipeline pig of claim 2, wherein the at least one wheel comprises a pair of axially spaced apart wheels.

5. The pipeline pig of claim 1 further comprising a first annular seal element disposed axially between and in abutting relationship with the sleeve housing most proximal to the tail end of the pipeline pig and a first wheel of the at least one wheel.

6. The pipeline pig of claim 5, wherein the first annular seal lines an inner wall of the sleeve housing most proximal to the tail end of the pipeline pig.

7. The pipeline pig of claim 5, wherein the turbine wheel is disposed within the first annular seal.

8. The pipeline pig of claim 2, further comprising a second annular seal element disposed axially between and in abutting relationship with the sleeve housing most proximal to the nose end of the pipeline pig and a second wheel of the at least one wheel.

9. The pipeline pig of claim 1, wherein the circumferential brush comprises bristles or an abrasive material.

10. (canceled)

11. The pipeline pig of claim 1, wherein the circumferential brush comprises an uninterrupted circumferential cleaning surface or a circumferential cleaning surface that defines at least one gap.

12. (canceled)

13. The pipeline pig of claim 1, wherein the sleeve housing most proximal to the tail end of the pipeline pig is mounted on the central shaft by a disc defining a plurality of disc openings that permit the axial fluid flow through the fluid flow path.

14. The pipeline pig of claim 13, wherein the plurality of disc openings are configured to increase velocity of the axial fluid flow through the disc openings.

15. The pipeline pig of claim 13, wherein the plurality of disc openings are configured to direct the axial fluid flow tangentially onto the vanes of the turbine wheel.

16. (canceled)

17. The pipeline pig of claim 1, wherein the vanes of the turbine wheel are removably attached to a hub of the turbine wheel.

18. (canceled)

19. (canceled)

20. The pipeline pig of claim 1, wherein either one or both of the sleeve housings defines a flange for mounting of a scraper disc or a scraper cup.

21. A scraper disc for a pipeline pig, the scraper disc defining a longitudinal direction parallel to a longitudinal axis of a pipeline when the scraper disc is inserted therein, and a radial direction normal to the longitudinal direction and extending outwardly from a central point of the scraper disc, the scraper disc comprising:
(a) a body formed from a resilient material and having an outer circumference; and
(b) at least one insert formed from a wear-resistant material, wherein the at least one insert is incorporated into the body and defines at least one edge coinciding with the outer circumference of the body for scraping against an inner wall of a pipeline.

22. The scraper disc of claim 21, wherein the body is molded, and the insert is cast incorporated into the body.

23. The scraper disc of claim 21, wherein the resilient material comprises an elastomer.

24. The scraper disc of claim 23, wherein the elastomer comprises a polyurethane material or a rubber material.

25-40. (canceled)
